(19) United States
(12) Patent Application Publication
(10) Pub. No.: US 2003/0218072 A1
(43) Pub. Date: Nov. 27, 2003

(54) Method for the manufacture of a smart label, and a smart label

(75) Inventor: Marko Hanhikorpi, Pirkkala (FI)

Correspondence Address: FITCH EVEN TABIN AND FLANNERY, 120 SOUTH LA SALLE STREET, SUITE 1600, CHICAGO, IL, 60603-3406, US

(73) Assignee: Rafsac Oy

(21) Appl. No.: 10/410,071

(22) Filed: Apr. 9, 2003

Related U.S. Application Data
(63) Continuation-in-part of application No. PCT/FI01/00911, filed on Oct. 19, 2001.

(30) Foreign Application Priority Data
Nov. 1, 2000 (FI) 20002405

(51) Int. Cl. G06K 19/06

(52) U.S. Cl. 235/492

(57) ABSTRACT

The invention relates to a method for the manufacture of a smart label. In the method, the smart label is provided with at least one oscillating circuit comprising at least one coil and at least one capacitor. Further in the method, at least one tuning element is formed in the oscillating circuit, for tuning of the oscillating circuit. The tuning of the oscillating circuit is performed, if necessary, by deactivating one or more of said tuning elements.

The present invention relates to a smart label and a method for the manufacture of a smart label. More specifically, a smart label is provided with at least one oscillating circuit including at least one coil, at least one capacitor and at least one inductive tuning element for tuning the oscillating circuit. The oscillating circuit is arranged to be tuned, if necessary, by deactivating one or more of said inductive tuning elements.

In this description, a smart label refers particularly to an electronic circuit which is formed in an adhesive laminate or another self-adhesive material and to which the required operating voltage is supplied by means of a resonance circuit formed in the smart label. Furthermore, such a smart label comprises an integrated circuit, such as an RF-ID circuit or the like, containing e.g. a memory.

### BACKGROUND

In one prior art system, energy is transferred to the smart label by means of an electromagnetic field having a frequency of about 13.56 MHz. Thus, the smart label is provided with a resonance circuit, preferably a serial resonance circuit, which is tuned exactly to said frequency. In such a situation, the relatively high operating voltage required by the electronic circuit of the smart label can also be induced from a relatively long distance. Typically, with such an arrangement, it is possible to achieve reading distances of even one metre, if the resonance circuit is tuned to the right frequency. Such an arrangement is used e.g. in various identification applications (RF-ID, Radio Frequency Identification tag), in which at least identification data is stored on an integrated circuit placed on a smart label. Such a smart label can be used in connection with products, wherein product information can be read at a distance by means of the smart label. Furthermore, several passage control systems apply the RF-ID technology for identification of persons and for checking rights of passage.

As the RF-ID technology is based on the use of a radio-frequency electro-magnetic field, the use of this technique is limited in several countries by various official regulations. Typically, the frequency band allocated for the use of the RF-ID system is limited in such a way that the bandwidth is about ±2.5% on both sides of the medium frequency. For example, with said medium frequency of 13.56 MHz, this means that the frequency range applied in the system is approximately from 13.22 to 13.90 MHz. As a high Q value (typically 60 to 100) and thereby high frequency selectivity is required of the oscillation circuits of the smart label, the control of the frequency of the oscillating circuit is one of the most important criteria in the quality assurance of the smart label and in the maximization of the process yields.

The manufacture of the coil for the oscillating circuit of the smart label involves several factors which cause deviations. In particular, stray capacitances cause significant deviations in the resonance frequency of the oscillation circuit in ready smart labels. It has been found in practice that the greatest deviation is due to the conductor (link) connecting the coil terminals, and particularly variations in the thickness of the medium used as a dielectric between the conductor and the coil. Typically, the deviation is in the order of 1 to 2 pF, which may, in practice, mean a frequency variation of even about 0.4 MHz. The capacitor of the oscillating circuit is normally integrated in the integrated circuit contained in the smart label. Typically, the production tolerance of capacitors is in the order of ±5%, which means, as a frequency shift, a frequency deviation of even about 0.5 MHz. Thus, the above-mentioned frequency deviations easily cause a frequency deviation of 0.5 to 0.7 MHz. In some cases, the frequency deviation can be in the order of even one megahertz. This means that it is not possible to achieve a sufficiently good reading distance with all the smart labels made in smart label manufacturing processes, because the tuning circuits of the smart labels are off the desired frequency. This also induces imaginary components in the impendance of the oscillating circuit.

Another problem with smart labels of prior art relates to the fact that the oscillating circuits of smart labels are inductance-weighted. Thus, the oscillating circuits tend to be off-tuned, if they come to the direct vicinity of a suitable medium. An example of such an application is a smart label integrated on a book cover or a product package. As a result of the off-tuning, different types of coils must be used for different applications, wherein the process of manufacturing products becomes more complicated in view of quality assurance and production control, thereby increasing the costs of the product in which the price is a crucial factor.

A smart label is known in which a tuning capacitor is added in the oscillating circuit. Such a smart label comprises a substrate made of polyethylene, an aluminium layer being provided on its both sides. The thickness of the substrate layer is in the order of 50 μm, and the thickness of the aluminium layers is about 30 μm. The tuning capacitor thus consists of two aluminium layers, a polyethylene layer being provided as a dielectric layer therebetween. Such a smart label is tuned by first measuring the operating frequency of the oscillating circuit and then cutting off a certain part of the tuning capacitor with a laser. Thus, the capacitance of the tuning capacitor is changed, which changes the tuning frequency of the oscillating circuit. One problem in this solution is that the thickness variation of the polyethylene layer can be several micrometres, which causes that the change in the capacitance of the tuning capacitor is not necessarily the same at different points of the tuning capacitor, although a part of equal size were cut off. It is thus difficult to estimate the size of the part to be cut off beforehand, wherein the measuring and cutting steps must be repeated, if necessary, until the oscillating frequency desired for the oscillating circuit is achieved at a sufficient precision. Furthermore, as the tuning is performed by cutting off a substantially rectangular piece with a fixed size, the operation is slow, the allowed tolerances of the smart label web in the machine and transverse directions are relatively small, and the tuning device is expensive. Due to the above-mentioned disadvantages, the use of such a tuning method is expensive and slow, particularly in such manufacturing processes, in which the smart label web 16 comprises several smart labels in the width direction.

### SUMMARY

It is an aim of the present invention to eliminate the above-mentioned drawbacks to a major extent and to provide a method for the manufacture of a smart label, in which the effects of the production tolerances can be eliminated in a significantly easier way than in methods of prior art. Furthermore, it is an aim of the present invention to provide a smart label, whose oscillating circuit can be tuned to the correct frequency after the manufacture more easily than in smart labels of prior art. The invention is based on the idea that the oscillating circuit to be formed on the smart label is provided with capacitive and/or inductive tuning means for implementing the tuning. More precisely, the method and smart label according to the present invention includes at least one inductive tuning element formed as a wire loop connected to the coil.

By means of the present invention, considerable advantages are achieved when compared with methods and smart labels of prior art. The tuning of the smart label of the invention after the manufacture is easy and fast, wherein the effect of production tolerances on the oscillating frequency can be eliminated at the tuning stage. Thus, the reliability of the smart labels becomes better and faster than in smart labels of prior art. Furthermore, the yield of the process of manufacture of a smart label can be improved, because variations in production tolerances can be eliminated, and the need for tuning and the change caused by the tuning can be determined relatively precisely on the basis of measurements. Thus, also the manufacturing costs of smart labels in large series become smaller than when using methods of prior art.

### BRIEF DESCRIPTION OF THE DRAWINGS

In the following, the invention will be described in more detail with reference to the appended drawings, in which

FIG. 1a shows a top view of a smart label according to a preferred embodiment of the invention,

FIG. 1b shows the cross-section of a smart label of FIG. 1a at point A-A in a reduced view,

FIG. 2 shows, in a reduced cross-section, a tuning device, by which a smart label according to an advantageous embodiment of the invention can be tuned,

FIG. 3 shows a top view of a smart label according to another advantageous embodiment of the invention, and

FIG. 4 shows the electric equivalent coupling in a smart label according to an advantageous embodiment of the invention.

### DETAILED DESCRIPTION

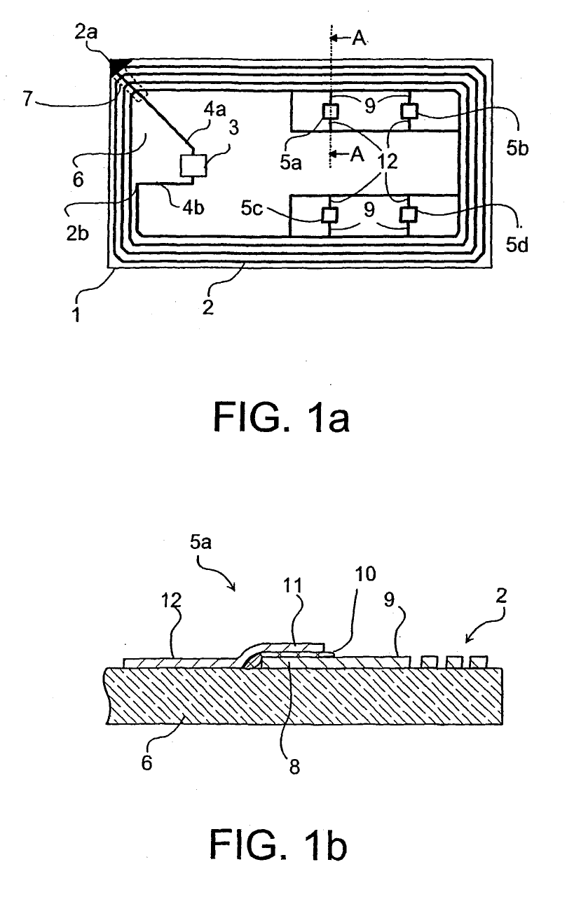

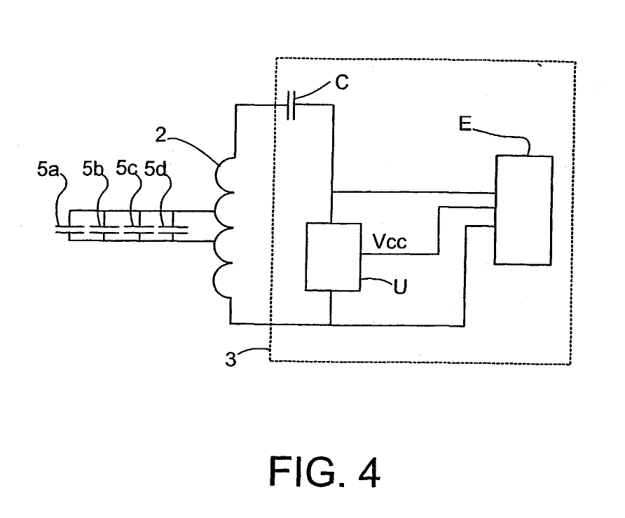

In the following, a smart label 1 according to a first advantageous embodiment of the invention will be described with reference to FIGS. 1a and 1b as well as the electric equivalent coupling of FIG. 4. In the manufacture of the smart label 1 according to the invention, it is possible to use manufacturing methods known as such. The smart label is formed on a suitable dielectric substrate 6, whose at least one surface is provided with one or more electroconductive layers. This electroconductive layer is provided with a desired circuitry pattern e.g. to form a coil 2 as well as to couple an integrated circuit 3 to the coil conductors. Furthermore, the ready smart label contains an adhesive surface and a film protecting the same. Smart labels can be made by mass production, wherein it is possible to manufacture a smart label web having the width of one or more labels simultaneously, the smart labels being arranged one after another.

The smart label 1 comprises a coil 2 which is preferably formed as a wire loop wound at least around the edge areas of the smart label 1, for example by printing an electroconductive printing ink onto the surface of the substrate 6. The smart label 1 is also provided with an integrated circuit 3 which is e.g. an integrated circuit intended for so-called RF-ID applications, comprising for example a memory and at least one capacitor C. The terminals of the coil 2 are connected by conductors 4a, 4b to the integrated circuit. In the integrated circuit, said capacitor C is preferably coupled in series at the pin of one conductor of the integrated circuit 3 with the rest of the electronics E contained in the integrated circuit. Thus, this conductor is coupled with either of the conductors 4a, 4b of the coil 2 and, in a corresponding manner, the second conductor of the integrated circuit is coupled with the other of the conductors 4a, 4b of the coil 2. Consequently, a serial resonance circuit is formed, comprising the coil 2 and the capacitor C included in the integrated circuit 3. Furthermore, the integrated circuit 3 is provided with means U, by which electromagnetic energy supplied via the serial resonance circuit can be transformed to a suitable operating voltage Vcc for the electronics E of the integrated circuit.

The smart label 1 of FIG. 1 is further provided with four tuning elements 5a-5d which, in this embodiment, are capacitive tuning elements, i.e. capacitors. It is obvious that the number of tuning elements is not restricted to four but it may vary in the different applications. Within the scope of the present invention, at least one tuning element is made for the smart label.

The tuning elements 5a-5d are coupled preferably in parallel, wherein the total tuning capacitance is the sum of the capacitances of the single tuning elements 5a-5d. The tuning elements 5a-5d, coupled in parallel, are connected to the coil 2, wherein the oscillating circuit consists of a coil 2, a capacitor in the integrated circuit 3, as well as the tuning elements 5a-5d. FIG. 4 also shows the electrical equivalent coupling for such a tuning circuit.

The tuning elements 5a-5d are preferably made at the same process stage and of the same materials as the conductor 4a connecting the terminals of the coil 2. The lower electrode is of for example aluminium or copper, the medium is preferably of a silk-printable dielectric material, and the upper electrode is preferably of silver paste or a combination of silver paste and electrolytically deposited copper. Thus, no other costs are induced in the manufacture of the tuning elements than the material costs, which constitute a very small part of the total costs. The steps of manufacture of the electrical components for a smart label according to the invention are taken for example in the following way. A conductive layer to form the coil 2 is made on the substrate by printing, evaporating or by another known method. In this connection, it is also possible to manufacture the first electrode 8 for the capacitors to be used as the tuning elements 5a-5d, as well as the conductors 9 connecting the first electrodes to the coil 2. Next, a dielectric 7 is made, for the purpose of isolating the conductor 4a from the other turns of winding in the coil 2. Also, a dielectric layer 10 for the tuning elements 5a-5d is preferably made at this stage. The conductors 4a and 4b are formed at the next stage. The purpose of the conductor 4a is to connect the first terminal 2a of the coil 2 to one pin of the integrated circuit 3. In a corresponding manner, the purpose of the conductor 4b is to connect the second terminal 2b of the coil 2 to another pin of the integrated circuit 3. After this, it is possible to make a second electrode 11 for the tuning elements as well as conductors 12 for connecting the second electrodes to the coil 2.

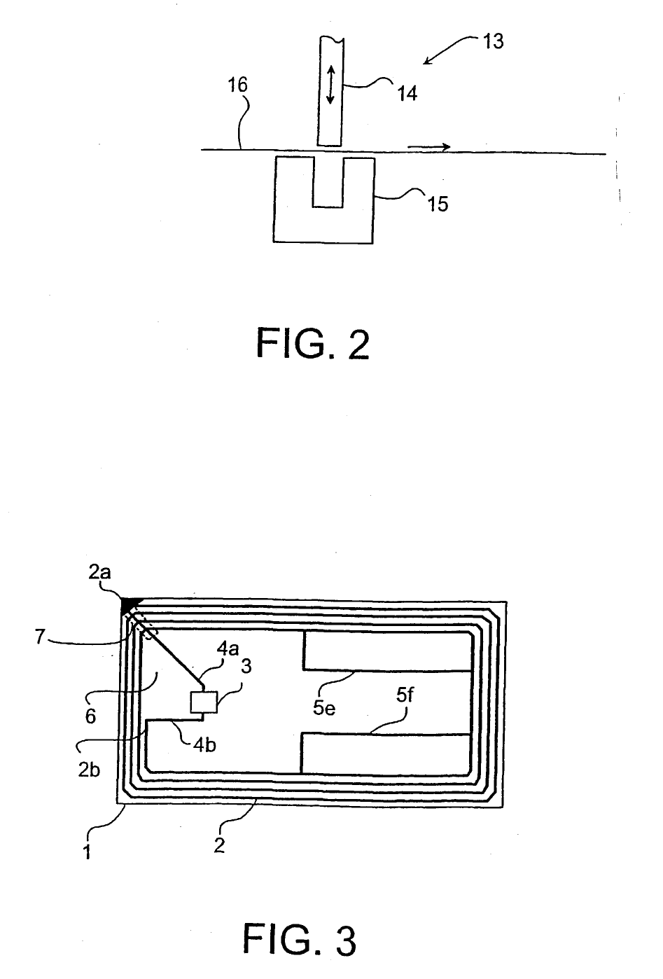

The tuning of the smart label 1 according to the invention can be performed for example in the following way. After the integrated circuit 3 has been attached to the smart label 1, the frequency of the oscillating circuit is measured and the need for tuning is determined. The tuning is performed by deactivating a necessary number of tuning elements 5a-5d. If, for example, the capacitance of the tuning elements is about 1 pF, a change of about 0 to 4 pF can be made in the total capacitance, depending on the number of tuning elements deactivated. The deactivation is performed for example mechanically, as shown in a reduced cross-section in FIG. 2. A tuning tool 13 comprises a ram head 14 and a counterpiece 15. The smart label web 16 consisting of smart labels is led between the ram head 14 of the tuning tool 13 and the counterpiece 15. The smart label web 16 is preferably positioned optically by means of cameras, wherein the position of each smart label in relation to the tuning tool 13 is detected. At the stage when a tuning element to be deactivated is placed against the tuning tool, the movement of the smart label web 16 can be stopped, if necessary, and a hole is punched by the ram head 14 at the electrodes 8, 11 of the tuning element or at either of the electrode conductors 9, 12, wherein the deactivated tuning element will no longer substantially affect the oscillating frequency of the oscillating circuit.

One or more tuning tools 13 can be provided, depending on the application. When one tuning tool is used, it must be possible to move it at least in a direction substantially transverse to the direction of movement of the smart label web 16 (in the width direction), if there are several smart labels next to each other in the smart label web. If several tuning tools are used, several tuning elements can be deactivated simultaneously, if necessary. If a mechanical tuning tool is used, the waste from the punching can be removed for example by negative pressure or by suction.

The tuning elements are preferably placed on the smart label in such a way that they are in one or several rows seen in the direction of movement of the smart label web 16. For example in the smart label of FIG. 1a, four tuning elements are placed in two rows. By this arrangement, it is possible to reduce the need for moving the tuning tool in the width direction of the smart label web. If the number of tuning tools in the width direction of the smart label web 16 is the same as the number of tuning elements rows in this direction, the tuning tools do not need to be moved in the width direction to perform the tuning.

The tuning tool used can also be another tool suitable to breaking, for example a laser which is used to burn off the conductor or tuning element. If lasers are used, it is possible to use one or more lasers which can be installed stationary, wherein preferably as many lasers are used as there are tuning element rows to be tuned, or it is possible to use movable lasers, wherein the laser beam is focused on the deactivation point of the tuning element to be deactivated at the time. If stationary tuning tools are used, the smart label web 16 is focused and stopped each time so that a tuning tool is placed against the tuning element to be deactivated. If a stationary tuning tool is used, the mechanical implementation of the device to be used for tuning can be made simpler and the working rate higher than when movable tuning heads are used.

Yet another tuning tool that can be used is a so-called cutting platen press. The cutting press can be placed for example above the smart label web 16, wherein a lower tool is underneath the web, or vice versa. When a cutting platen press is used, the waste formed by punching is sucked by negative pressure preferably to the side of the press.

If the silk screen printing method is used for forming the dielectric layer of the tuning elements, the layer thickness can be determined more precisely than when a substrate dielectric is used. In this case, also the precision of the tuning elements is improved, which also improves the tuning accuracy.

FIG. 3 shows a smart label complying with another advantageous embodiment of the invention. In this embodiment, the tuning elements are inductive tuning elements 5e, 5f. The tuning can thus be performed by cutting the conductor of one or more tuning elements 5e, 5f, wherein the inductance of the coil 2 is changed. In this embodiment, one advantage is that the cutting of the wire loop can be performed at substantially any point of the loop, wherein the cutting accuracy is not very significant. The cutting can be performed by tools corresponding to the tuning tools 13 used in the case of capacitors. By affecting the coil inductance, the frequency shift in practical smart labels is always the same, at the precision of a few percent, because the reproducibility of the line is good in the processes of manufacture of the coil.

In capacitive tuning, it is even possible to achieve a control range of about 1 to 1.5 MHz, if the nominal values of the capacitors are set to for example 0.5, 1, 2 and 3 pF. It is obvious that the tuning elements do not need to be identical with each other, but tuning elements with different tuning values can be used, wherein a different effect on the resonance frequency can be achieved with different tuning elements.

It is obvious that the present invention is not limited solely to the above-presented embodiments, but it can be modified within the scope of the appended claims.

What is claimed is:

1. A method for the manufacture of a smart label, which smart label is provided with at least one oscillating circuit comprising at least one coil and at least one capacitor, in which method the oscillating circuit is provided with at least one inductive tuning element for tuning the oscillating circuit, and the oscillating circuit is tuned, if necessary, by deactivating one or more of said inductive tuning elements, wherein said at least one inductive tuning element is formed as a wire loop connected to said coil.

2. The method according to claim 1, in which a target resonance frequency is determined for the oscillating circuit and an allowable deviation from the target resonance frequency is determined for the resonance frequency, wherein that the tuning of the oscillating circuit comprises at least the following steps:
measuring the resonance frequency of the oscillating circuit,
comparing the measured resonance frequency with said target resonance frequency,
if the deviation of the resonance frequency from the target resonance frequency exceeds the allowed deviation, determining the need to change the resonance frequency of the oscillating circuit,
to implement the need to change, determining at least one deactivatable inductive tuning element, and
deactivating at least one inductive tuning element as determined in the preceding step.

3. The method according to claim 1 or 2, wherein the area of the wire loop is at least about ⅛ of the area of the innermost turn of the coil.

4. The method according to claim 3, wherein it comprises at least two inductive tuning elements, and that each tuning element is placed on different parts of the coil.

5. The method according to claim 4, wherein the smart label is provided with at least one integrated circuit.

6. A smart label which is provided with at least one oscillating circuit comprising at least one coil, at least one capacitor, and at least one inductive tuning element for tuning the oscillating circuit, and the oscillating circuit is arranged to be tuned, if necessary, by deactivating one or more of said inductive tuning elements, wherein said at least one inductive tuning element is formed as a wire loop connected to said coil.

7. A smart label according to claim 6, wherein the inductive tuning elements are connected to a coil by means of at least one conductor, and that the deactivation is arranged to be performed by disconnecting at least one conductor which connects the inductive tuning element to be deactivated to the coil.

8. The smart label according to claim 6 or 7, wherein the area of the wire loop is at least about ⅛ of the area of the innermost turn of the coil.

9. The smart label according to claim 8, wherein it comprises at least two inductive tuning elements, and that each tuning element is placed on different parts of the coil.

10. The smart label according to claim 9, wherein the smart label comprises at least one integrated circuit.

11. The smart label according to claim 10, wherein said capacitor is placed in said integrated circuit.
